(19) United States
(12) Patent Application Publication
(10) Pub. No.: US 2007/0291157 A1
(43) Pub. Date: Dec. 20, 2007

(54) CAMERA WITH AUTOMATIC DAYTIME/NIGHTTIME FEATURE

(76) Inventors: BEIJING DING, KANSAS CITY, MO (US); DARIN STEPHENS, INDEPENDENCE, MO (US)

Correspondence Address: HOVEY WILLIAMS LLP, 2405 GRAND BLVD., SUITE 400, KANSAS CITY, MO, 64108, US

(21) Appl. No.: 11/762,981

(22) Filed: Jun. 14, 2007

Related U.S. Application Data
(60) Provisional application No. 60/804,876, filed on Jun. 15, 2006.

(51) Int. Cl. H04N 5/225

(52) U.S. Cl. 348/360

(57) ABSTRACT

A camera (10) with an automatic daytime/nighttime feature includes a lens (16) for focusing an image, an image capture element (14) for capturing a digital representation of the image focused by the lens, the image capture element (14) operable to capture images in both the visible light and infrared portions of the electromagnetic spectrum, and a filter (18) for preventing passage of substantially all electromagnetic waves within the infrared portion of the electromagnetic spectrum. An actuator (20) moves the filter (18) between a first position wherein the filter (18) is at least partially interposed between the lens (16) and the image capture element (14), and a second position wherein the filter (18) is not interposed between the lens (16) and the image capture element (14). A controller (44) automatically causes the filter (18) to be moved between the first position and the second position at times of day indicated by instructions received via an interface (46).

### RELATED APPLICATION

The present application is a nonprovisional patent application and claims priority benefit, with regard to all common subject matter, of earlier-filed U.S. provisional patent application titled “TRAIL CAMERA WITH AUTOMATIC DAYTIME/NIGHTTIME FEATURE”, Ser. No. 60/804,876, filed Jun. 15, 2006, incorporated by reference into the present document.

### BACKGROUND

1. Field

The present technology relates to camera devices. More particularly, embodiments of the technology involve a camera operable to capture images in the presence or absence of ambient light using a single image capture element.

2. Description of Related Art

It is often desirable to capture images in the absence of visible ambient light, such as at night or in enclosed, unlit locations. To capture images in the absence of visible light, “night vision” cameras have been developed that use infrared light emitting diodes to illuminate a field of view with infrared light and use an infrared image capture element to capture images of the field of view based on the infrared light. Dual-mode cameras have been developed that capture images based on ambient visible light (i.e., “daytime” mode) and images based on infrared light (i.e., “night vision” mode). Such cameras may include a single image capture element capable of capturing both visible light images and infrared light images. To enhance the infrared light images, such cameras often include infrared light emitters (“flashes”) that are invisible to humans and animals.

Conventional dual-mode cameras must be placed in either the daytime mode or the night vision mode when used or installed in the field. Due to the inconvenience of manually switching the camera, operators typically leave such cameras in one of the two modes for long periods of time. Use of the infrared light emitter results in daytime images that are black and white with an occasional undesirable pink hue and nighttime images that are black and white.

Accordingly, there is a need for an improved camera operable to capture images in the presence and absence of visible light that does not suffer from the limitations of conventional cameras.

### SUMMARY OF THE INVENTION

The present teachings provide an improved camera for capturing images in the presence or absence of ambient light that does not suffer from the problems and limitations of the prior art. Particularly, embodiments of the present teachings provide a camera comprising an image source, an image capture element, a filter, and an actuator.

The image capture element may be operable to detect both visible and infrared light. The filter prevents passage of light defined by a first portion of the electromagnetic spectrum, such as infrared light, and allows passage of light defined by a second portion of the electromagnetic spectrum, such as visible light. The actuator moves the filter between a first position wherein the filter is at least partially interposed between the image source and the image capture element, and a second position wherein the filter is not interposed between the image source and the image capture element.

If the filter is operable to block infrared light, the filter may be interposed between the image source and the image capture element in the presence of ambient light to prevent image deterioration due to infrared light, and may be removed in the absence of ambient light to allow infrared light to reach the image capture element.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Preferred implementations of the present technology are described in detail below with reference to the attached drawing figures, wherein:

FIG. 1 is a front elevation view of a camera constructed according to principles of the present teachings and including a lens and filter assembly, the camera illustrated in broken lines;

FIG. 2 is a generally front and side perspective view of the camera of FIG. 1 with a face of the camera fragmented to illustrated the lens and filter assembly encased in the camera, the camera shown with a cover in an open position exposing a user interface and a plurality of battery receptacles;

FIG. 3 is a generally front perspective view of the lens and filter assembly of FIGS. 1 and 2;

FIG. 4 is a generally rear perspective view of the lens and filter assembly of FIG. 3;

FIG. 5 is a generally front exploded view of the lens and filter assembly of FIGS. 3 and 4;

FIG. 6 is a generally rear exploded view of the lens and filter assembly of FIGS. 3 and 4;

FIG. 7a is a rear elevation view of the lens and filter assembly of FIGS. 3-6 illustrating a filter component in a first position;

FIG. 7b is a rear elevation view of the lens and filter assembly of FIGS. 3-6 illustrating the filter component in a second position; and

FIG. 8 is a schematic diagram of various components of the camera of FIGS. 1 and 2.

### DETAILED DESCRIPTION

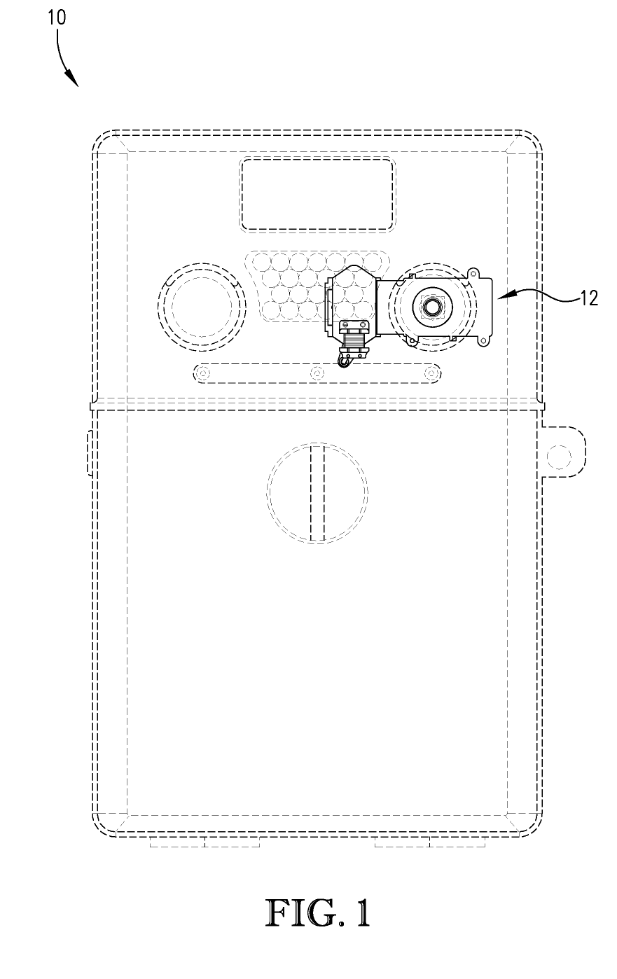

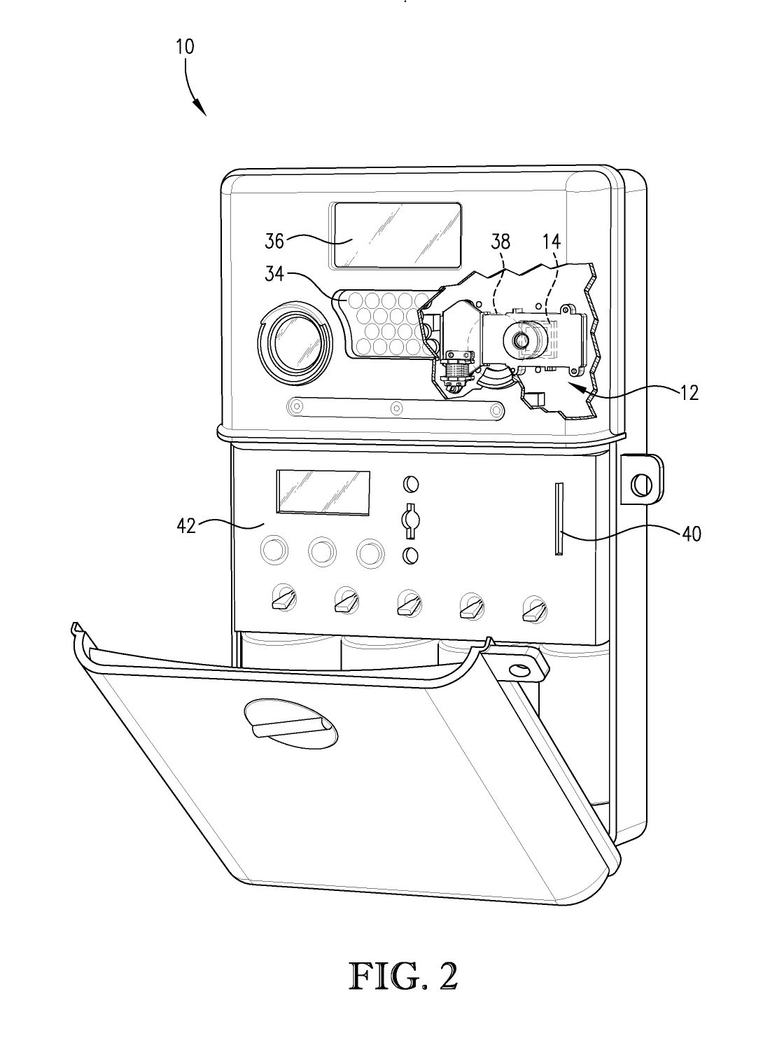

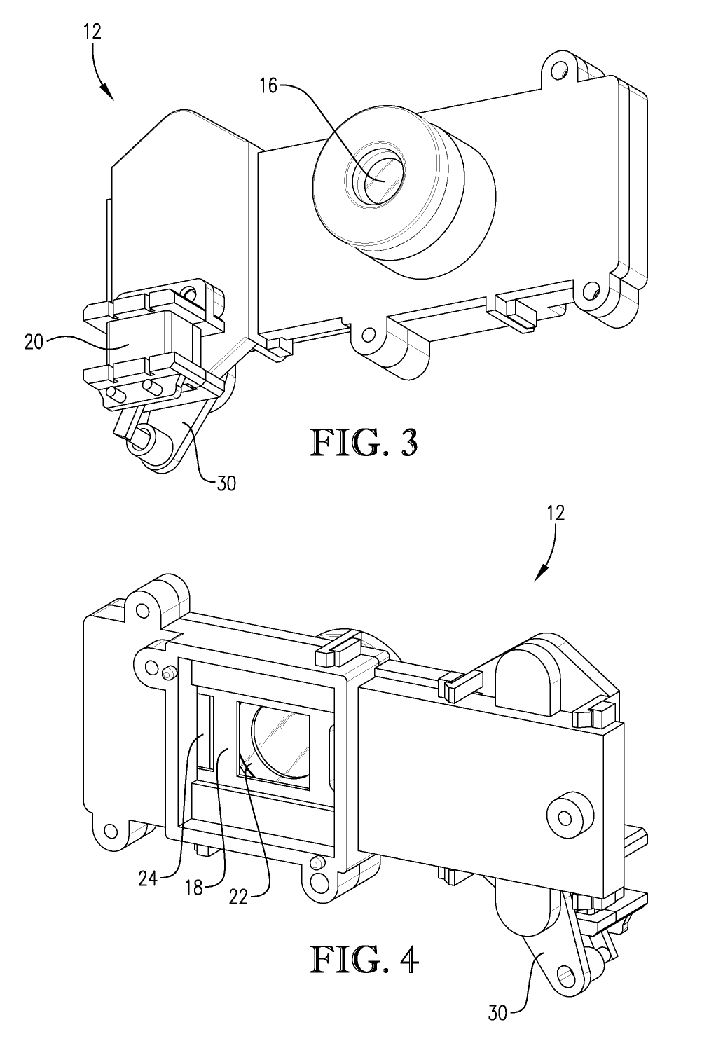

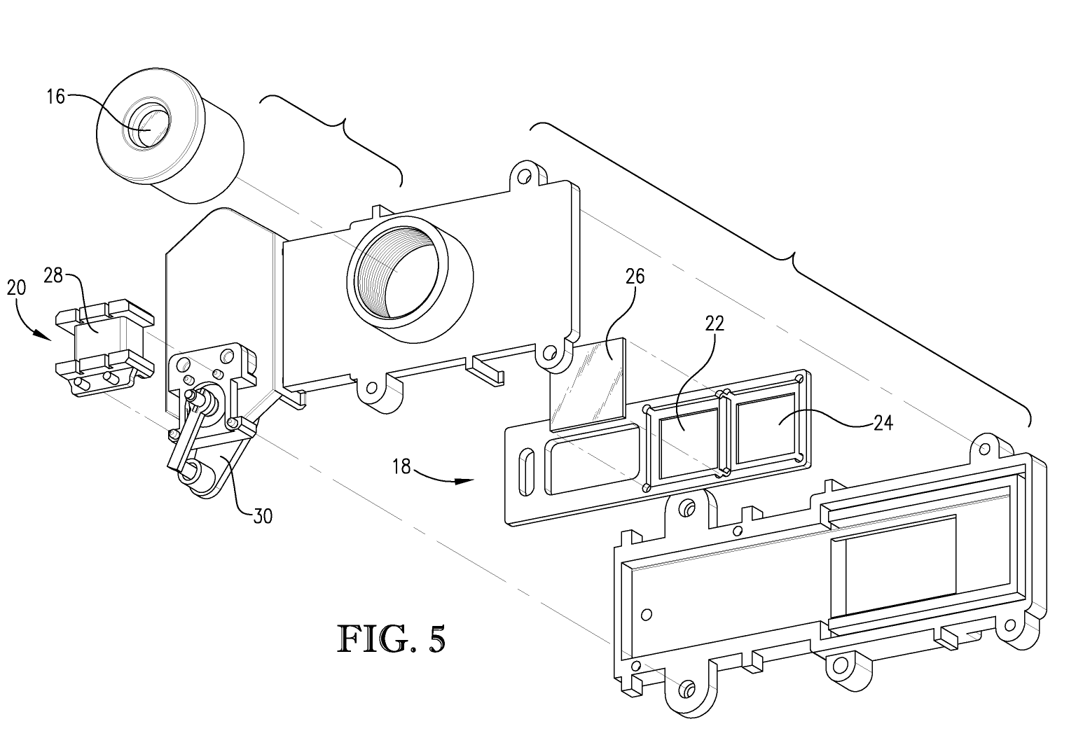

A camera embodying principles of the present teachings is illustrated in FIGS. 1 and 2 and designated generally by the reference numeral 10. The camera 10 includes a lens and filter assembly 12 operable to direct light toward an image capture element 14 and selectively filter the light directed toward the image capture element 14. The lens and filter assembly 12 may be encased within the camera 10, as illustrated, and interposed between a camera lens and an image capture element, as explained below. Referring also to FIGS. 3-6, the lens and filter assembly 12 generally comprises a lens 16, a filter component 18, and an actuator 20.

As used herein, “light” includes electromagnetic radiation that is detected by the image capture element 14, and includes visible light as well as one or more portions of the electromagnetic spectrum in addition to visible light. Particularly, “light” includes electromagnetic radiation in the visible (wavelengths within the range of about 380 nm to about 750 nm) and infrared (wavelengths within the range of about 750 nm to about 1 mm) portions of the electromagnetic spectrum.

The lens 16 may be a conventional glass or plastic lens for focusing or otherwise directing light onto the image capture element 14. The lens 16 is but one example of an image source that may be used in the lens and filter assembly 12. An alternative image source may include, for example, a simple aperture that does not focus or otherwise direct light passing through the aperture.

The filter component 18 selectively filters a portion of the light passing from the lens 16 to the image capture element 14. The illustrated filter component 18 includes a first window 22 and a second window 24, wherein the first window 22, the second window 24, or both, include a filter to remove or block at least a portion of the light passing through the lens 16. The filter component 18 is selectively positioned such that either the first window 22 or the second window 24 is interposed between the lens 16 and the image capture element 14. One or both of the windows 22, 24 may include an insert, such as the insert 26, with the filter characteristics described above.

The first window 22 and the second window 24 may pass overlapping portions of the electromagnetic spectrum. For example, the first window 22 may include an infrared filter to pass substantially all light except for infrared light, while the second window 24 may pass substantially all light, including infrared light. In this example, the filter component 18 may be used to switch between a night mode wherein all light is passed, and a daytime mode wherein infrared light is blocked to prevent degradation of the image detected by the image capture element 14.

The actuator 20 selectively moves the filter component 18 between a first filter position wherein the first window 22 is interposed between the lens 16 and the image capture element 14, and a second filter position wherein the second window 24 is interposed between the lens 16 and the image capture element 14. Stated another way, the actuator 20 moves a filter between a first position wherein the filter at least partially intercepts light from the image source (lens 16), and a second position wherein the filter does not intercept light from the image source. Thus, the lens and filter assembly 12 selectively filters light passing from the lens 16 to the image capture element 14 by interposing different filter elements between the lens 16 and the image capture element 14. Because, the lens and filter assembly 12 physically moves one or more filter elements into a position interposed between an image source and an image capture element to filter light reaching the image capture element, a single image capture element 14 may be used to capture both visible light images and infrared images without image degradation caused by the influence of infrared light in visible light images.

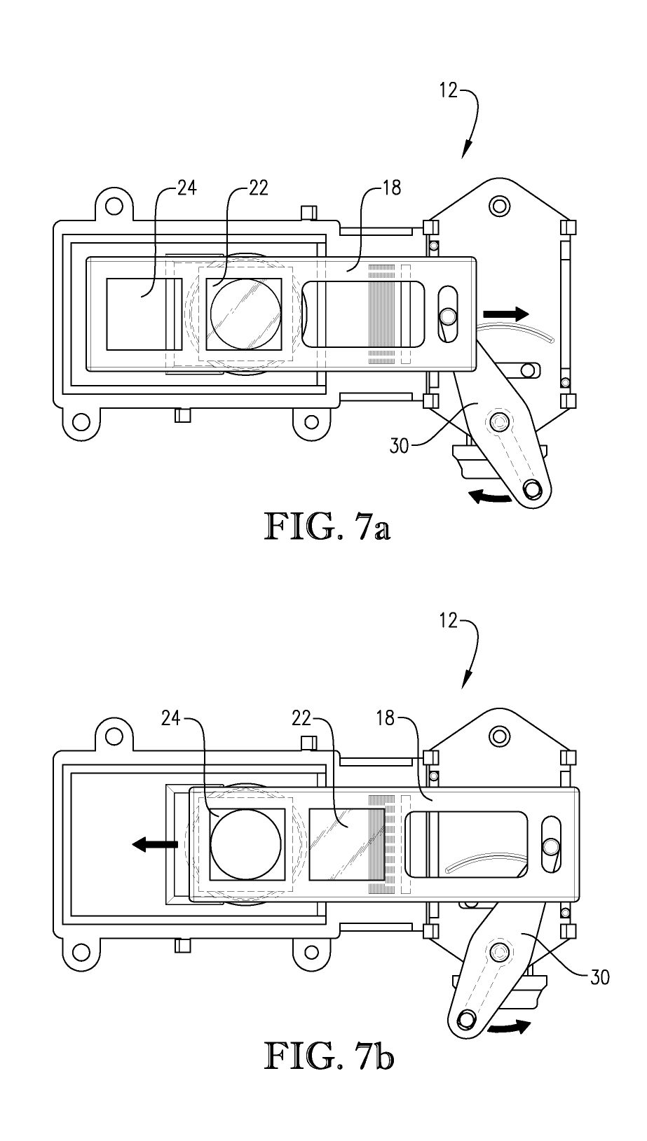

The illustrated actuator 20 includes an electromagnet 28 that moves an arm 30 between a first arm position and a second arm position according to a polarity of the magnetic field generated by the electromagnet 28. Thus, the arm 30 may include a magnetic element, such as a permanent magnetic, that is responsive to a magnetic field. Movement of the arm 30 between the first arm position and the second arm position causes the filter component 18 to move between the first filter position and the second filter position. The filter component 18 is illustrated in the first position in FIG. 7a and in the second position in FIG. 7b.

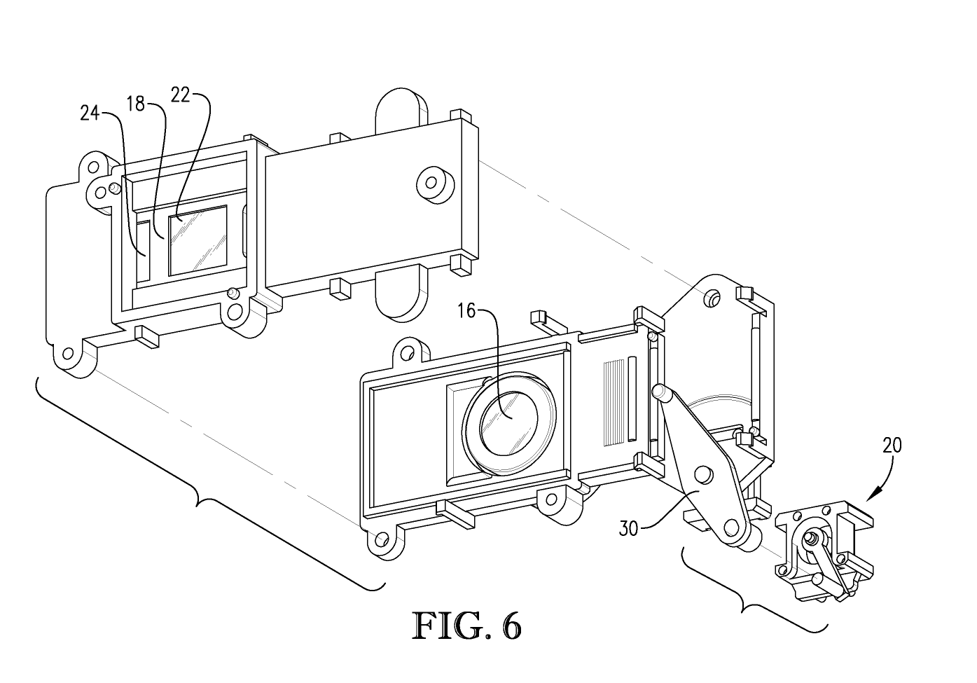

As illustrated in FIGS. 4 and 6, the lens and filter assembly 12 includes a chamber for encasing or receiving the image capture element 14. In particular, a plurality of walls extend generally rearwardly from the assembly 12 and substantially circumscribe a path of light originating from the lens 16. The walls define a substantially planar rim such that when the assembly 12 is secured to an external object with a planar surface, such as a printed circuit board, the walls of the chamber surround the image capture element 14 and contact the planar surface to prevent light from reaching the image capture element 14 from any source other than the lens 16. The assembly 12 may further include a plurality of attachment components including, for example, one or more internally-threaded, screw-receiving recesses.

It will be appreciated that these features of the lens and filter assembly 12 facilitate adaptation of the assembly 12 to various types of cameras by substantially modularizing the assembly 12. For example, the lens and filter assembly 12 can be physically attached to a camera by placing the assembly 12 on a printed circuit board supporting the image capture element 14 and securing the assembly 12 to the printed circuit board using the plurality of attachment components.

The lens and filter assembly 12 illustrated in the drawings and described above is an exemplary embodiment of various principles of the present teachings. It is noted that equivalents may be employed and substitutions made to the lens and filter assembly 12 without departing from the ambit of the present teachings. By way of example, a linear solenoid, electric motor, or other actuator may be used in place of the electromagnet 28 illustrated and described herein. Furthermore, the filter component 18 may include a single window, wherein the single window includes a filter such that interposing the single window between the image source and the image capture element 14 filters a portion of the light striking the image capture element 14.

An exemplary application of the lens and filter assembly 12 is illustrated in FIGS. 1 and 2, wherein the assembly 12 is mounted in the camera 10 used for discretely capturing images in the presence or absence of visible light. Such cameras are commonly used, for example, by hunters who wish to scout animal activity. The camera 10 has other uses as well, including, for example, security surveillance.

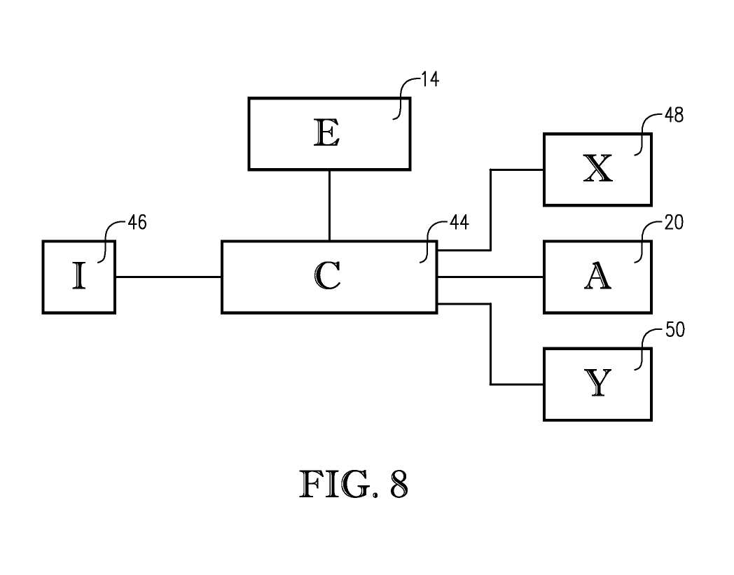

In addition to the lens and filter assembly 12 and the image capture element 14, the camera 10 may include, among other things, a passive infrared sensor 32 for detecting the presence of a person or animal; an infrared emitter 34 such as the illustrated array of infrared light emitting diodes; a visible light emitter 36; an outer camera lens 38; a memory receptacle 40; a control panel 42 including one or more user interface elements; and a controller 44 (FIG. 8) for generally controlling operation of the camera 10.

The passive infrared sensor 32 senses motion in a conventional manner, and may require infrared energy (heat) in addition to motion to trip the sensor 32. The infrared emitter 34 generates infrared light for the capture of images in the absence of visible light, such as at nighttime or in an unlit room. In order to capture images in the absence of visible light, the image capture element 14 senses visible light as well as infrared light. The visible light emitter 36 may be a standard flash, such as a xenon flash tube or other flash device, and may be used to capture images with little or no ambient light. The visible light emitter 36 may be used instead of the infrared emitter 34 where, for example, the user prefers visible light images.

Light enters the camera 10 through the outer camera lens 38 and strikes the lens 16. The memory receptacle 40 receives a memory element, such as a memory card or other data storage device, and enables communication between the memory element and the controller 44. The control panel 42 includes one or more user interface elements, such as buttons, switches, and a display. The control panel 42 thus enables users to interact with the controller 44 to configure operation of the camera 10, as explained below in greater detail.

A schematic diagram of various electric components of the camera 10 is illustrated in FIG. 8. The controller 44 generally controls operation of the electrical components of the camera 10, and is preferably a digital integrated circuit such as a general use, commercial off-the-shelf computer processor. Alternatively, the controller 44 may be a programmable logic device configured for operation with the camera 1 0,or may be an application specific integrated circuit (ASIC) especially manufactured for use in the camera 10.

While illustrated as a single component of the block diagram, the controller 44 may include two or more separate integrated circuits working in cooperation to control operation of the camera 10, and may include one or more analog elements operating in concert with or in addition to the digital circuit or circuits. The controller 44 may even comprise a plurality of discrete components. The controller 44 may operate in conjunction with a memory element (not shown) that stores data, instructions, or both used by the controller 44. The memory element may be internal or external to the controller 44.

In addition to the controller 44, the diagram illustrated in FIG. 8 illustrates an interface 46; the image capture element 14; the actuator 20; and a plurality of additional electrical components 48,50 that may correspond to one or more of the passive infrared sensor 32, infrared emitter 34, visible light emitter 36, or the memory receptacle 40 of the camera 10.

The interface 46 may be a user interface, a wireless interface, or both. Thus, the interface 46 may correspond, at least in part, to one or more elements of the control panel 42. Via the interface 46, a user may configure the controller 44 to automatically drive the filter component 18 to the first filter position at a first time of day and drive the filter component 18 to the second filter position at a second time of day via the actuator 20.

By way of example, a user may wish to filter out infrared light during the day to prevent image quality deterioration, but may wish to allow infrared light to reach the image capture element 14 at night to capture infrared images enhanced by the infrared emitter 34. Thus, the control panel 42 may include interface elements that enable a user to select a first time of day for switching to night mode and a second time of day for switching to day mode, wherein the controller 44 causes an infrared filter to be interposed between the lens 16 and the image capture element 14 in the day mode, and causes the infrared filter to be moved to a location not interposed between the lens 16 and the image capture element 14 in the night mode.

Although the present technology has been described with reference to the preferred embodiments illustrated in the attached drawings, it is noted that equivalents may be employed and substitutions made herein without departing from the scope of the invention as recited in the claims. It will be appreciated, for example, that the lens and filter assembly 12 may be used with a hand-held camera.

Having thus described preferred implementations of the present technology, what is claimed as new and desired to be protected by Letters Patent includes the following:

1. A camera comprising:
an image source;
an image capture element;
a filter for preventing passage of light corresponding to a first portion of the electromagnetic spectrum and allowing passage of light corresponding to a second portion of the electromagnetic spectrum; and
an actuator for moving the filter between a first position wherein the filter is at least partially interposed between the image source and the image capture element, and a second position wherein the filter is not interposed between the image source and the image capture element.

2. The camera as set forth in claim 1, the actuator comprising an electromagnet for moving the filter to the first position when charged to a first charge polarity, and for moving the filter to the second position when charged to a second charge polarity.

3. The camera as set forth in claim 1, further comprising:
an interface for receiving an input indicating a time when the actuator will move the filter to the first position and a time when the actuator will move the filter to the second position; and
a controller for driving the actuator according to the input received via the interface.

4. The camera as set forth in claim 3, the interface being chosen from the group consisting of a button pad, a touchscreen, and a wireless interface.

5. The camera as set forth in claim 1, the filter preventing passage of substantially all light corresponding to the infrared portion of the electromagnetic spectrum.

6. The camera as set forth in claim 1, the image capture element being operable to capture visible light images and infrared images.

7. A camera comprising:
an image source;
an image capture element;
a filter component for selectively filtering light passing from the image source to the image capture element, the filter including a first window for passing light corresponding to a first portion of the electromagnetic spectrum and a second window for passing light corresponding to a first portion of the electromagnetic spectrum; and
an actuator for moving the filter between a first position wherein the first window is interposed between the image source and the image capture element and a second position wherein the second window is interposed between the image source and the image capture element.

8. The camera as set forth in claim 7, the actuator comprising an electromagnet for moving the filter to the first position when charged to a first charge polarity, and for moving the filter to the second position when charged to a second charge polarity.

9. The camera as set forth in claim 7, further comprising:
an interface for receiving an input indicating a time when the actuator will move the filter to the first position and a time when the actuator will move the filter to the second position; and
a controller for driving the actuator according to the input received via the interface.

10. The camera as set forth in claim 9, the interface being chosen from the group consisting of a button pad, a touchscreen, and a wireless interface.

11. The camera as set forth in claim 7, the first window blocking infrared light but passing visible light, and the second window passing visible light and infrared light.

12. The camera as set forth in claim 7, the image capture element being operable to capture images in both the visible light and infrared portions of the electromagnetic spectrum.

13. A camera comprising:
a lens for focusing an image;
a digital image capture element for capturing a digital representation of the image focused by the lens, the digital image capture element operable to capture images in both the visible light and infrared portions of the electromagnetic spectrum;
a filter element for preventing passage of substantially all electromagnetic waves within the infrared portion of the electromagnetic spectrum; and
an actuator for moving the filter between a first position wherein the filter is at least partially interposed between the lens and the image capture element, and a second position wherein the filter is not interposed between the lens and the image capture element.

14. The camera as set forth in claim 13, further comprising:
an interface for receiving an input indicating a time when the actuator will move the filter to the first position and a time when the actuator will move the filter to the second position; and
a controller for driving the actuator according to the input received via the interface.

15. A filter device comprising:
an image source;
a filter for preventing passage of light corresponding to a first portion of the electromagnetic spectrum and allowing passage of light corresponding to a second portion of the electromagnetic spectrum;
an actuator for moving the filter between a first position wherein the filter at least partially intercepts light from the image source, and a second position wherein the filter does not intercept light from the image source.

16. The filter device as set forth in claim 15, the filter preventing passage of substantially all light corresponding to the infrared portion of the electromagnetic spectrum.

17. The filter device as set forth in claim 15, further comprising a plurality of walls extending from the device and substantially circumscribing a path of light from the image source, the walls defining a substantially planar rim and being positioned such that the filter is interposed between the rim and the image source when in the first position.

18. The filter device as set forth in claim 15, further comprising a plurality of attachment components for securing the device to an external object.

19. The filter device as set forth in claim 18, the plurality of attachment components including at least one internally-threaded recess.

20. The filter device as set forth in claim 15, the image source including a lens.

21. A method of automatically operating a camera, the method comprising:
receiving instructions indicating a first point in time and a second point in time; and
substantially automatically moving a filter to a first position wherein the filter is at least partially interposed between an image source and an image capture element at the first point in time, and moving the filter to a second position wherein the filter is not interposed between the image source and the image capture element at the second point in time, the filter preventing passage of light corresponding to a first portion of the electromagnetic spectrum and allowing passage of light corresponding to a second portion of the electromagnetic spectrum.
